(19) United States
(12) Patent Application Publication
(10) Pub. No.: US 2022/0403817 A1
(43) Pub. Date: Dec. 22, 2022

(54) BIFURCATING WIND DIVERTER FOR VERTICAL-AXIS TURBINE GENERATOR

(71) Applicant: Onshore Wind, LLC, Marstons Mills, MA (US)

(72) Inventors: Daniel Muric, Falmouth, MA (US); Chris McDonald, Marstons Mills, MA (US); Stephen A. Darrow, Merritt Island, FL (US)

(73) Assignee: Onshore Wind, LLC, Marstons Mills, MA (US)

(21) Appl. No.: 17/843,437

(22) Filed: Jun. 17, 2022

Related U.S. Application Data
(60) Provisional application No. 63/211,676, filed on Jun. 17, 2021.

(51) Int. Cl. F03D 3/04; F03D 3/00; F03D 3/02

(52) U.S. Cl. CPC F03D 3/0418; F03D 3/005; F03D 3/02; F03D 9/25

(57) ABSTRACT

A vertical-axis wind turbine generator includes two or more rotor assemblies, each rotor assembly having two or more wind turbine blades mounted for rotation, preferably those having a Savonius configuration. A cowling includes a nose portion forming a bifurcating wind diverter, in which the bifurcated airflow is directed in order to cause counter directional flow of the wind turbine blades. According to at least one version, the cowling further includes a cover portion that defines a venturi chamber above the rotating blades to draw air into the top of the turbine above the rotating blades and create a vacuum, thereby reducing resistance. The cowling can be part of an existing wind turbine or alternatively replace an original cowling as a retrofit.

### CROSS REFERENCE TO RELATED APPLICATION

This application claims priority pursuant to relevant portions of 35 U.S.C. § § 119 and 120 to U.S. Patent Application Ser. No. 63/211,676, filed Jun. 17, 2021, which is incorporated by reference in its entirety.

### TECHNOLOGICAL FIELD

The subject matter disclosed herein generally relates to wind turbines, and more specifically, to the inclusion of a bifurcating wind diverter for use with vertical-axis wind turbine generator, preferably those having Savonius blades. The wind diverter is configured to orient incoming airflow towards the wind turbine blades and is preferably formed in a nose portion of a cowling that bifurcates the incoming airflow. The cowling further includes a cover portion, which when the cowling is attached to the wind turbine, forms a venturi chamber above the rotating blades. The herein described features increase overall efficiency, produce greater torque as a result of multidirectional flow, as well as reduce resistance of blade rotation.

### BACKGROUND

There is a growing market to transition from fossil fuels to renewable energy. However, the limitations of solar, large wind turbines, and other competitive renewable energy sources are stunting that progress. Over the last two decades, as fuel costs have skyrocketed, the quality of our environment due to air quality, pollution, and general neglect has had a significant negative impact on quality of life in many urban centers around the world. Solar energy, as implemented, is only effective during daylight hours and in communities typically not hindered by cloud cover. Large wind turbines are costly, restricted to specific locations, and are often met with community push back from people who are more interested in maintaining their pristine view than adopting the benefits communities would receive by having a large wind turbine installed in the area.

Certain vertical-axis wind turbines (VAWT) used for generating wind power are inherently inefficient. For example, vertical-axis wind turbine blades having an S-shaped (Savonius) configuration having alternate convex and convave sides produce power based on a difference in air pressure across the blades as one set of blades retreat from the wind and the other set of blades advances into the wind. This particular form (helical) of blade construction provides a drag-driven rotor design. Accordingly, there is a prevailing need to improve the overall efficiencies (e.g., increasing torque) of vertical wind turbine generators, particularly those having a helical blade configuration, such as Savonius blades. In addition, there is another need to provide turbines that are structurally capable of functioning, even in the presence of hurricane force winds.

### BRIEF DESCRIPTION

Therefore and according to at least one aspect, there is provided a vertical-axis wind turbine generator having a plurality of wind turbine blades supported for rotation on a base assembly. A wind diverter is disposed and configured to orient/divert incoming airflow towards the wind turbine blades. In at least one embodiment, the vertical-axis wind turbine generator includes two or more vertical-axis rotor assemblies, each rotor assembly supporting a plurality (e.g., three) wind turbine blades in spaced relation within the unit. According to the invention, the plurality of wind turbine blades of each rotor assembly are driven by the diverted airflow in opposing rotational directions (i.e., one rotor driven in a clockwise direction and one in a counter-clockwise direction). The wind diverter bifurcates and orients the incoming airflow in order to drive the wind turbine blades of each of the rotor assemblies to promote lifting of each rotating blade as it moves outside of the generator unit. According to a preferred version, each rotor assembly supports a plurality of Savonius wind turbine blades in which the wind diverter creates multidirectional flow and increased torque.

The herein described vertical-axis wind turbine generator further includes a cowling (or cover or hood). According to a preferred version, the cowling can include a nose portion at one end that forms the wind diverter, as well as a cover portion that can be in the form of an inverted NACA scoop and creates a venturi chamber that is configured to help relieve the backpressure resulting from the wind turbine blades rotating inside the generator unit by drawing air out of the top of the generator unit and creating a vacuum which helps draw the wind turbine blades in without resistance. In addition and in order to reduce the pressure build up on the inner surface of the wind diverter, an inverted NACA scoop in the form of a vent can also be provided on the cowling, preferably on the nose portion, in order to release the pressure.

According to at least another aspect, there is provided a method for improving the efficiency of a vertical-axis wind turbine generator having two or more rotor assemblies, each of the rotor assemblies having two or more wind turbine blades that are disposed mounted for rotation on a base assembly. According to the method, a cowling is provided having an integral or attachable wind diverter that is disposed in relation to the two or more rotor assemblies, wherein the wind diverter is configured to bifurcate incoming airflow to cause the two or more wind turbine blades to be directed in counter rotational directions.

According to at least one aspect, the cowling is formed with a nose section defining the wind diverter and a cover section, preferably formed in the shape of an inverted NACA scoop. The cover section is disposed in relation to the rotor assemblies wherein a venturi chamber is formed above the rotating blades at an open end of the cover section draws air from the top of the generator unit and creates a vacuum that assists in drawing the wind turbine blades without resistance. In at least one version, one or more ports can be provided in the nose portion to relieve backpressure.

According to yet another aspect, there is provided a wind diverter that is configured to improve the efficiency of a vertical axis wind turbine and more specifically those having rotating Savonius wind turbine blades, the wind diverter being an integral nose portion of a cowling designed to be fitted onto the generator unit that is configured to bifurcate incoming airflow. In at least one version, the cowling includes a cover portion that includes an open end and a domed surface configured to be disposed above the rotating blades forming a venturi chamber and to draw air from the top of the turbine and create a vacuum that assists in drawing the rotating blades without resistance. In at least one version, the nose portion can include one or more ports to relieve backpressure created by the increased airflow.

A number of advantages are realized based on the herein described vertical-axis wind turbine generator. For example, increased efficiencies are realized and most preferably in vertical-axis wind turbine generators having Savonius wind turbine rotor assemblies, including increased torque. Vertical-axis wind turbines having varied number of rotor assemblies (multi-axis) and various number of blades in each rotor assembly can accommodate this design.

Another advantage is that the herein described vertical-axis wind turbine generator is configured to withstand high winds, including hurricane force winds.

Yet another advantage is that the cowling including the wind diverter can be retrofitted to existing vertical-axis wind turbine generator units.

These and other features and advantages will be readily apparent from the following Detailed Description, which should be read in conjunction with the accompanying drawings.

Both the foregoing summary and the following Detailed Description provide examples and are explanatory only. Accordingly, the foregoing summary and the following detailed description should not be considered to be restrictive. This summary is not intended to identify key features or essential features of the claimed subject matter. Nor is this summary intended to be used to limit the claimed subject matter's scope. Further, features or variations may be provided in addition to those set forth herein. For example, embodiments may be directed to various feature combinations and sub-combinations described in the following Detailed Description.

### BRIEF DESCRIPTION OF THE DRAWINGS

A more particular description of the invention briefly summarized above may be had by reference to the embodiments, some of which are illustrated in the accompanying drawings. It is to be noted, however, that the appended drawings illustrate only typical embodiments of this invention and are therefore not to be considered limiting of its scope, for the invention may admit to other equally effective embodiments. Furthermore, the drawings may contain text or captions that may explain certain embodiments of the present disclosure. This text is included for illustrative, non-limiting, explanatory purposes of certain embodiments detailed in the present disclosure. Thus, for further understanding of the nature and objects of the invention, references can be made to the following detailed description, read in connection with the drawings in which:

FIG. 1A illustrates a top front perspective view of a vertical-axis wind turbine generator made in accordance with aspects of the invention;

FIG. 1B illustrates a bottom front perspective view of the vertical-axis wind turbine generator of FIG. 1A;

FIG. 2 illustrates a partial rear elevation view of the vertical-axis wind turbine generator of FIGS. 1A and 1B;

FIG. 3 illustrates a partial side elevation view of the vertical-axis wind turbine generator of FIGS. 1A-2, this view being provided with the rotors removed to show various internal components;

FIG. 4A illustrates a partially exploded view of the vertical-axis wind turbine generator of FIGS. 1A-3 with the wind turbine blades and cowling/wind diverter being removed;

FIG. 4B illustrates a partially exploded view of the vertical-axis wind turbine generator of FIGS. 1-4 with the cowling/wind diverter removed;

FIG. 5A illustrates an partially exploded elevational view of the vertical-axis wind turbine generator of FIGS. 1A-4B, depicted with the wind turbine blades and cowling/wind diverter removed;

FIG. 5B illustrates another partially exploded elevation view of the vertical-axis wind turbine generator, depicted with the wind turbine blades and cowling/wind diverter removed;

FIG. 6 illustrates a front view of the cowling with integrated wind diverter in accordance with aspects of the invention;

FIG. 7A illustrates a side elevational view of a vertical-axis wind turbine generator made in accordance with aspects of the invention, depicting the effect of the wind diverter based on incoming airflow; and

FIG. 7B illustrates a top view of the vertical-axis wind turbine generator of FIG. 7A, showing the airflow directions.

### DETAILED DESCRIPTION

The following describes a preferred embodiment of a cowling that includes a wind diverter for use with a vertical-axis wind turbine generator, in which the cowling can be originally provided or alternatively retrofitted to an existing vertical-axis wind turbine generator, as well as a related method of improving the efficiency of vertical-axis wind turbine generators, made in accordance with aspects of the present invention. It will be understood that a number of modifications and variations can be made that encompass the intended scope of this invention. It should also be noted that the accompanying drawings are intended to present salient features of the herein described assemblies and related method. These drawings should not be relied upon, however, for scaling purposes. In addition, a number of terms are used throughout the following description in order to provide a suitable frame of reference for the accompanying drawings. These terms, unless so specifically indicated otherwise, should not be interpreted to limit the overall scope of the herein described assembly and method.

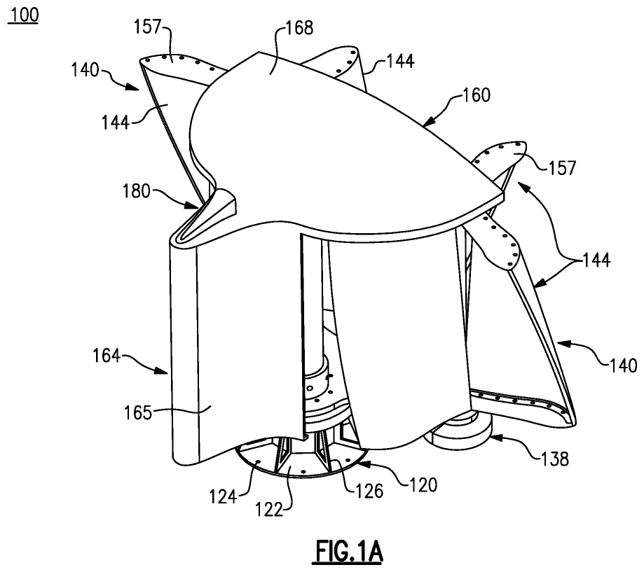

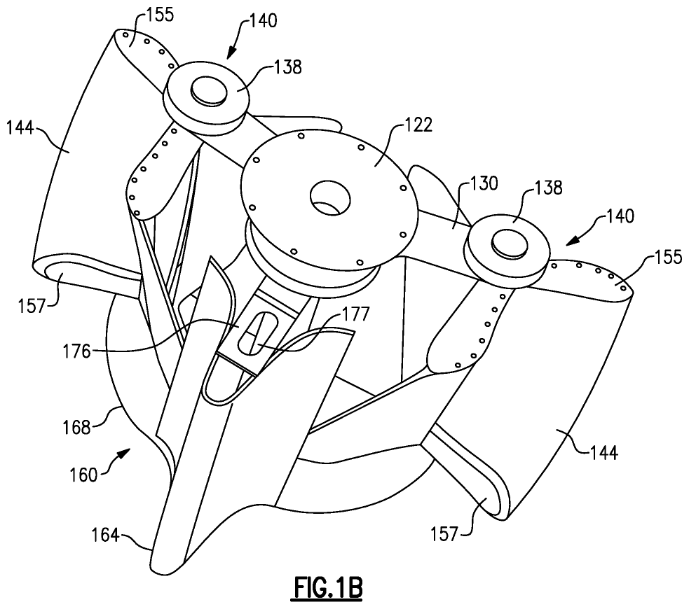

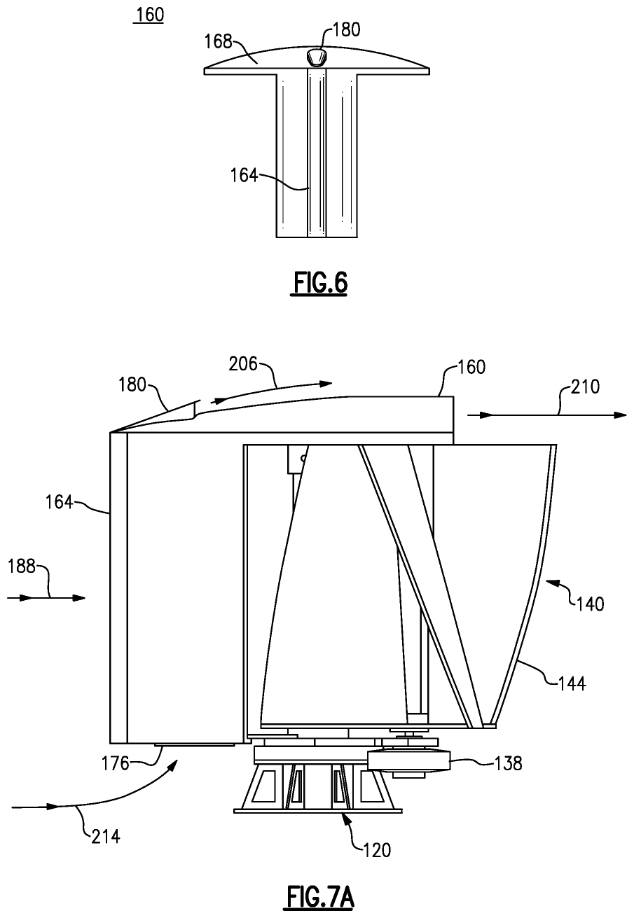

FIGS. 1-7B depict an exemplary embodiment of an exemplary wind turbine generator that is equipped in accordance with aspects of the present invention. More specifically, a vertical-axis wind turbine generator 100 has a pair of rotor assemblies 140 defining a dual vertical-axis wind turbine in which each of the rotor assemblies 140 are configured to support a plurality of wind turbine blades 144 for rotation and more specifically those having a Savonius blade construction.

With reference to FIGS. 1A-5B, the vertical axis wind turbine generator 100 is defined by a base assembly 120 that supports a plurality of vertical-axis rotor assemblies 140, as well as a cowling 160, which is sized and configured to cover at least a portion of the generator 100. As discussed herein, the cowling 160 is further configured with a wind diverter that acts to distribute incoming air flow in relation to the rotor assemblies 140. According to this specific embodiment, two (2) rotor assemblies 140 are provided, each rotor assembly 140 having three (3) supported wind turbine blades. It will be understood however, from the following description that the number of rotor assemblies 140 and number of rotatable wind turbine blades 144 can be suitably varied. Each of the components of this vertical-axis wind turbine generator 100 will now be described in greater detail.

Referring to FIGS. 1A-5B, the base assembly 120 is configured for mounting to a support surface by any suitable means and includes a circular lower base plate 122 having a plurality of circumferentially spaced mounting holes 124 at an outer periphery of the lower base plate 122. A plurality of struts 126 disposed in a spaced relation extend upwardly between a top surface of the lower base plate 122 and an underside of an upper base plate 128 disposed in parallel relation with the lower base plate 122. According to this specific embodiment, the base assembly is made from 5/16″ steel powder wherein the lower base plate has a larger diameter than that of the upper base plate 128, the latter also having a circular configuration according to this embodiment. Six struts 126 are provided according to this embodiment, though the number of struts can be suitably varied.

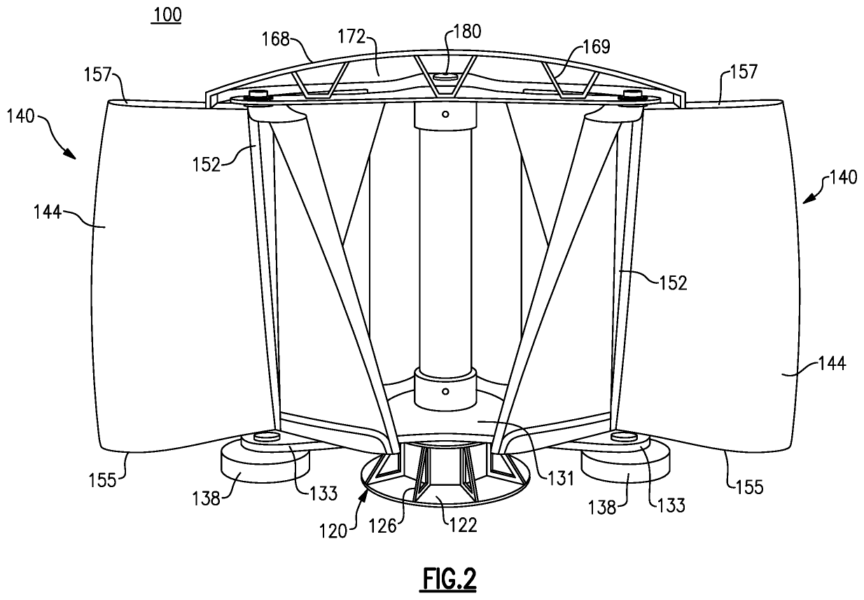

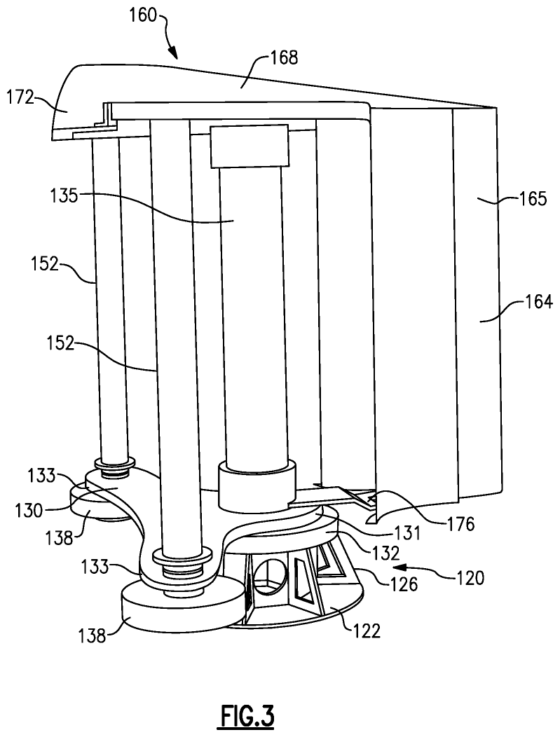

A turbine base plate 130 is centrally mounted above the upper base plate 128 and coupled thereto. As best shown in FIGS. 2 and 3, the turbine base plate 130 is a planar member having a center portion 131 and two lobe portions 133 radially extending from the center section 131. A base bushing 132 is disposed and mounted between the underside of the turbine base plate 130 at the center section 131 and the upper base plate 128 of the base assembly 120. The base bearing 132 is a slew bearing that allows the entire unit to turn 360 degrees. Each of the radially extending lobe portions 133 of the turbine base plate 130 are disposed on opposite sides of the base assembly 120.

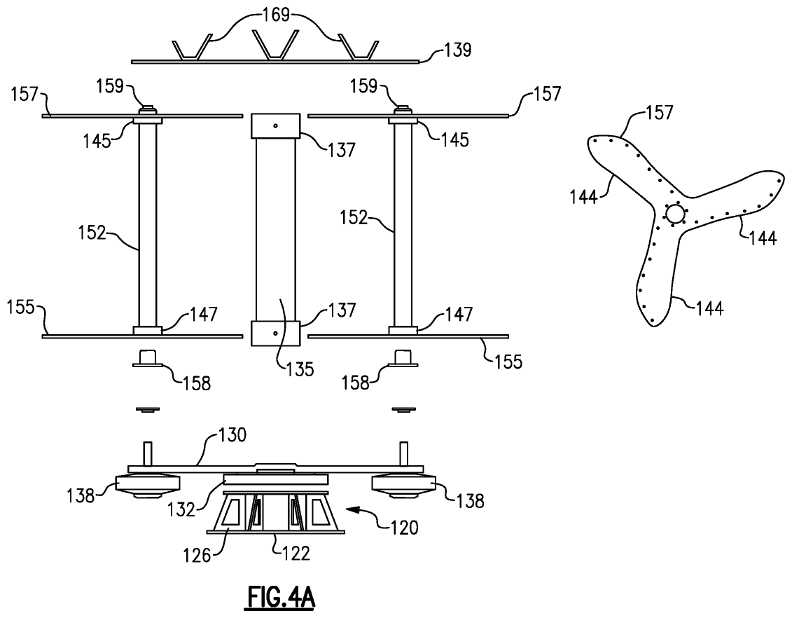

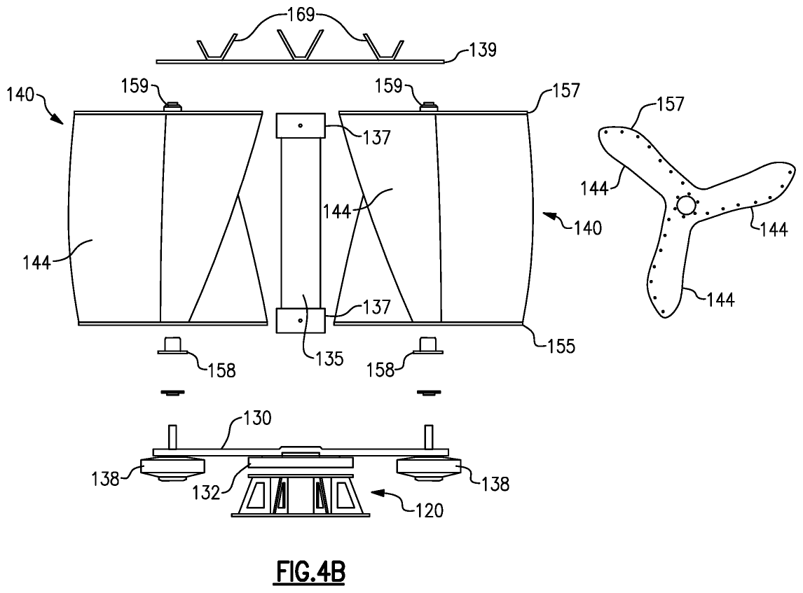

The herein described wind turbine generator 100 further includes a main support tube 135 that is fixedly mounted at opposing lower and upper ends to respective main tube bushings 137, as shown most clearly in FIG. 4B. The opposing ends of the main support tube 135, including the main tube bushings 137, are bolted or otherwise secured to the center section 131 of the turbine base plate 130 and a top plate 139, respectively, wherein the main support tube 135 is in axial alignment with the base assembly 120. Each of the top plate 139 and the turbine base plate 130 according to this specific embodiment are fabricated from Aluminum 6061-T6, although other suitable structural materials can be utilized.

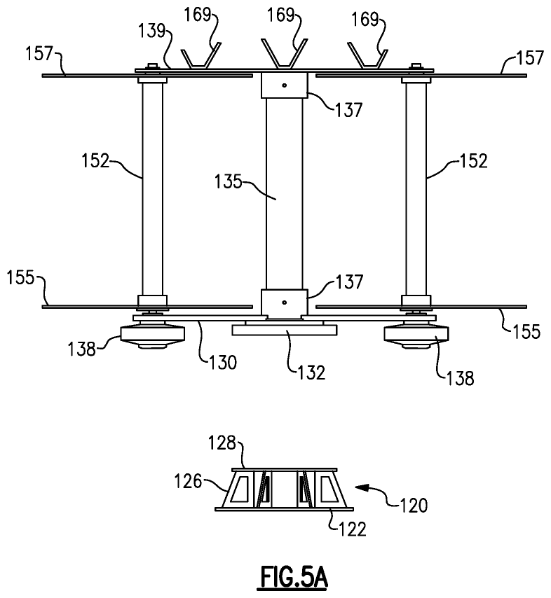

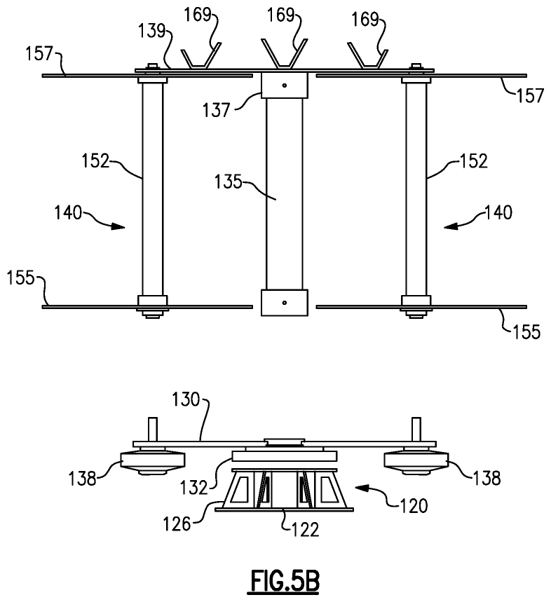

According to this specific embodiment and with reference to FIGS. 4A, 4B, 5A and 5B, the pair of rotor assemblies 140 are disposed in relation to the radially extending lobe sections 133 of the turbine base plate 130. Each rotor assembly 140 includes a plurality (three according to this embodiment) of wind turbine blades 144 that are mounted in spaced circumferential configuration (120 degrees apart) relative to a vertically disposed blade support pole or post 152. According to this exemplary embodiment, the wind turbine blades 44 are substantially S-shaped and defined by a Savonius configuration, details of which are well known and require no further information, except as applicable to the herein described embodiment. A lower blade bracket 155, and an upper blade bracket 157 are attached to the bottommost and uppermost edge surfaces, respectively, of the wind turbine blades 144. Each blade bracket 155, 157 is a single member shaped to engage the edges of the blades 144 and including a center opening. The upper and lower blade brackets 155, 157 are made from a durable aluminum or aluminum alloy according to this embodiment although other suitable materials can be utilized.

Each rotor assembly 140 includes respective upper and lower tube bushings 145, 147 that are secured to opposing ends of the blade support post 152. The upper and lower tube bushings 145, 147 are attached by fasteners to a plurality of mounting holes, best shown in FIGS. 4A and 4B that are disposed in spaced circumferential fashion about the center hole or opening formed in the upper and lower blade brackets 155, 157.

Each of the vertically disposed blade support posts 152 having the supported wind turbine blades 144, are mounted for rotation in relation to the remainder of the wind turbine generator 100. More specifically and according to this embodiment, a blade bearing 159 is disposed between the top plate 139 and the upper end of each blade support post 152. The lower end of each blade support post 152 receives a bottom blade mount bushing 158, the latter being attached to a generator 138, the latter being attached to the underside of each of the radially extending portions 133, FIG. 4B, of the turbine base plate 130 and including a rotating shaft extending upwardly through the bushing 158. According to this embodiment, the generator 138 is a permanent magnet DC generator, though the specific type of generator is not necessarily germane to the actual invention. Accordingly, these latter components are well known in the field and require no further discussion. As provided, each of the blade support posts 152 are supported for rotation about a defined vertical axis, with the herein described generator 100 having two parallel vertical axes.

The cowling 160 is disposed in relation to the herein described turbine generator 100, as shown in FIGS. 1A, 1B, 2, 3 and 6. According to this specific embodiment, the cowling 160 is defined by a single or unitary section made from a suitable structural material and is defined by a nose portion 164 and an outwardly extending cover portion 168. The nose portion 164, which is provided at a front end of the assembly 100 opposite the rotor assemblies 140, is defined by a pair of vertical walls 165 extending outwardly from a terminus or front end. The vertical walls 165 have a height dimension that is coextensive with that of the rotor assemblies 140. A pressure vent 180 is provided in an upper surface of the nose section 164. The bottom side of the nose section 164 is open wherein an extension bracket 176 is attached to the top surface of the turbine base plate 130 extends substantially from the center section of the turbine base plate 130 and covers the bottom side of the nose section 164. An elongated opening or vent 177, FIG. 1B, is provided in the extension bracket 176, wherein the purposes of the pressure vent 180 and the elongated opening 177 will be discussed in a later section of this description.

The cover portion 168 of the cowling 160 is sized and configured for mounting to the top plate 139 of the assembly 100 using a plurality of hood supports 169 that are provided in spaced relation at a rear end of the top plate 139, wherein the open end of the cover portion 168 is essentially open. The cover portion 168 is defined by a domed (concave) surface that combined with the open rear end defines a venturi chamber 172, see FIG. 2, which is formed above each of the rotor assemblies 140. As discussed below, the cowling 160, and more specifically the nose portion 164, is sized and configured to act as a wind diverter in order to bifurcate incoming air flow and to direct the airflow in relation to the rotor assemblies 140 in order to create multidirectional (counter rotational) flow.

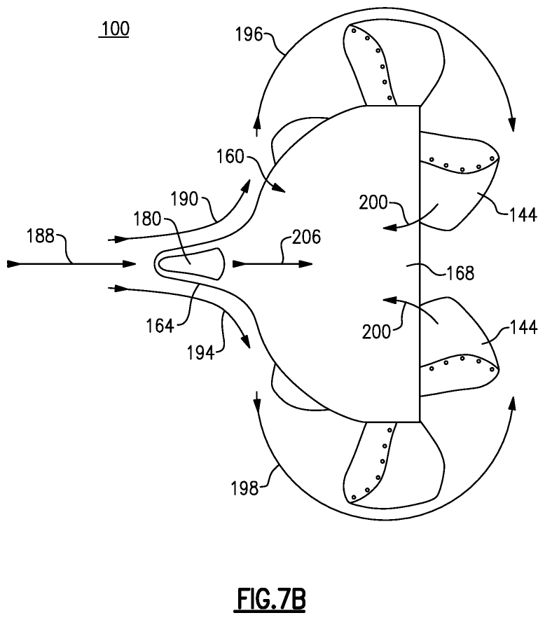

As depicted in FIGS. 7A and 7B, the shape of the nose portion 164 of the attached cowling 160 is configured to orient incoming airflow 188 and bifurcate the airflow, see arrows 190, 194 in order to drive the wind turbine blades 144 of each of the rotor assemblies 140 in counter rotational directions, as shown by arrows 196, 198. In one example, the airflow 188 is diverted at an angle of 45 degrees from normal (i.e., the direction of the airflow as it initially contacts the nose portion 164). Depending on the configurations and locations of the wind diverter 164 and the wind turbine rotor assemblies 140 and wind turbine blades 144, the airflow can be diverted at an angle in the range of 30 degrees to 60 degrees from normal.

As best shown in FIG. 7B, the redirected airflow 196, 198 drives the outer portion of the wind turbine blades 144 (one from each rotor assembly 140 that are moving outside of the generator unit (i.e., out from under the cowling 160). This airflow promotes lifting of each rotating wind turbine blade 144 as the blades 144 move outside of the unit. The cover portion 168 of the cowling 160 is in the form of an inverted NACA scoop, which includes the formed venturi chamber 172 disposed above the top plate 139. This formed chamber 172 helps relieve the backpressure resulting from blade rotation inside the assembly 100 by drawing air out of the top of the generator unit and creating a vacuum which helps draw the rotating blades 144, see arrow 200, in without resistance. In addition, in order to reduce the pressure build up on the inner surface of the nose portion 164, the pressure vent 180 is also preferably in the form of an inverted NACA scoop in order to release any pressure produced, as shown by arrow 206, FIG. 7A, wherein the extended slot 177 formed in the bracket 176 at the bottom of the nose section 164 also draws in air, arrow 214, moving vertically and also vented via the vent 180, see arrow 206, with a portion of the air also being vented through the open rear end of the cover section 168 of the cowling 160, see arrow 214. Each of the foregoing design modifications help eliminate resistance to blade rotation. In at least one version, the wind diverter (nose portion) is integral to the cowling 160, but the cover portion 168 and nose portion 164 can also be provided as separate components.

In addition to efficient energy production that is created by the cowling/wind diverter, the exemplary wind turbine generator 100 can be designed to withstand hurricane force winds. For example, as best seen in FIGS. 4A-5B, the base assembly 120 can be fabricated and produced using 5/16″ powder coated steel. In addition, the turbine base plate 130 and top plate 139 to which the rotor assemblies 140 are mounted can be made using 6061 T6 Aircraft Aluminum. Hole patterns for the generators 138 and hole patterns for the main bearing 132 can be provided in order to minimize or eliminate deflection of the turbine base plate 130.

As best can be seen in FIGS. 4A and 4B, in order to minimize stress riser in the blade support brackets 155, 157, a larger radius (e.g., 2 inches) can be used at the junctions between the wind turbine blades 144 of each rotor assembly 140.

It will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself

### PARTS LIST FOR FIGS. 1-7B

100 vertical axis wind turbine generator or assembly

120 base assembly

122 lower base plate

124 mounting openings or holes

126 struts

128 upper base plate

130 turbine base plate

131 center portion, turbine base plate

132 base bushing

133 radially extending lobe portions, turbine base plate

135 main support tube

137 main tube bushings

138 generators

139 top plate

140 rotor assemblies

144 wind turbine blades

145 upper blade tube bushings

147 lower blade tube bushings

152 blade support post

155 lower blade bracket

157 upper blade bracket

158 bottom blade mount bushings

159 blade bearings

160 cowling

164 nose portion (wind diverter)

165 vertical walls

168 cover portion

169 hood supports

172 venturi chamber

176 extension bracket

177 elongated opening or vent

180 pressure vent

188 airflow incoming, arrow

190 bifurcated airflow, arrow

194 bifurcated airflow, arrow

196 direction, blade rotation

198 direction, blade rotation

200 airflow, arrow

206 vented air, arrow

210 vented air, arrow

214 drawn in air, arrow

These and other modifications and variations will be readily apparent. For example, the overall number of rotor assemblies can be varied provided an equal number of rotor assemblies and wind turbine blades are provided on opposing sides of the wind diverter. It will be understood that different configurations of rotor assemblies 140 and blades 144 can be used with the invention. For example, any varied number of rotor assemblies can be used provided there is a complementary number (pairs) and in which each rotor assembly can include two or more supported blades (i.e., two, three, four, seven, eight, etc.)

1. A wind diverter for use in improving efficiency of a vertical axis wind turbine generator having two or more rotor assemblies, each rotor assembly having two or more wind turbine blades supported for rotation relative to a base assembly, the wind diverter comprising a cowling having a nose portion at a first end that outwardly expands to a cover portion configured to at least partially cover the two or more rotor assemblies at a second end.

2. The wind diverter according to claim 1, wherein the cover portion comprises a domed top surface and an open rear end at the second end, wherein the domed surface and open rear end are configured to act as a venturi chamber when the cover portion is placed on top of the two or more rotor assemblies.

3. The wind diverter according to claim 2, wherein the venturi chamber is configured to draw air from the top of the turbine generator and create a vacuum to reduce blade rotational resistance.

4. The wind diverter according to claim 3, wherein the nose portion includes at least one vent configured to relieve backpressure created by the rotation of the two or more rotor assemblies.

5. The wind diverter according to claim 4, wherein the nose portion includes an upper and a lower vent.

6. The wind diverter according to claim 1, wherein the nose portion is integral to the cowling. The wind diverter according to claim 1, wherein the cowling is retrofittable onto an existing vertical-axis wind turbine generator.

8. A vertical-axis wind turbine generator comprising:
a base assembly;
two or more rotor assemblies, each rotor assembly having two or more wind turbine blades mounted for rotation in relation to the base assembly; and
a wind diverter disposed in relation to incoming airflow, the wind diverter being configured to bifurcate the incoming airflow to cause counter rotation of the two or more wind turbine blades.

9. The vertical-axis wind turbine generator according to claim 8, wherein the wind diverter is a portion of a cowling configured to cover at least a portion of the rotor assemblies.

10. The vertical-axis wind turbine generator according to claim 9, wherein the wind diverter is an integral portion of the cowling.

11. The vertical-axis wind turbine generator according to claim 9, in which the wind diverter is defined by a nose portion of the cowling that outwardly extends to a cover portion and in which incoming airflow is caused to move about opposite sides of the nose portion before encountering the two or more rotor assemblies to create counter rotation thereof

12. The vertical-axis wind turbine generator according to claim 11, wherein the cover portion of the cowling defines a venturi chamber disposed above the top plate, the venturi chamber configured to draw air from the top of the generator and create a vacuum to reduce blade resistance.

13. The vertical-axis wind turbine generator according to claim 12, further comprising at least one vent formed in the nose portion of the wind diverter, the vent being disposed to relieve backpressure created by the two or more rotor assemblies.

14. The vertical-axis wind turbine generator according to claim 8, wherein the vertical-axis wind turbine generator is configured to operate with hurricane force winds.

15. The vertical-axis wind turbine generator according to claim 8, wherein the wind turbine blades of each rotor assembly are Savonius blades.

16. A method for improving energy efficiency of a vertical-axis wind turbine generator assembly having two or more rotor assemblies, each of the rotor assemblies having two or more wind turbine blades that are disposed mounted for rotation relative to a base assembly, the method comprising:
providing a cowling having a wind diverter; and
disposing the wind diverter in relation to the two or more rotor assemblies, wherein the wind diverter is configured to bifurcate airflow to cause the two or more rotor assemblies to be rotated in counter directions.

17. The method according to claim 16, wherein the wind diverter is formed from a cowling of the wind turbine generator, the cowling including a nose portion and an outwardly extending portion configured and shaped to cover a portion of the two or more rotor assemblies.

18. The method according to claim 17, wherein the cover portion includes a domed surface and an open end, defining a venturi chamber disposed above the two or more rotor assemblies that is configured to draw air from the top of the turbine and creating a vacuum to reduce blade resistance.

19. The method according to claim 17, further comprising forming at least one pressure vent in the nose portion to relieve backpressure of the incoming airflow.

20. The method according to claim 17, wherein the nose portion forming the wind diverter is integral to the cowling.
